(19) United States
(12) Patent Application Publication
(10) Pub. No.: US 2013/0195466 A1
(43) Pub. Date: Aug. 1, 2013

(54) TRANSMISSION METHOD AND TRANSMISSION SYSTEM

(71) Applicant: SONY CORPORATION, Tokyo (JP)

(72) Inventors: Naoto Nakamura, Tokyo (JP); Hiroyuki Yamagishi, Tokyo (JP)

(73) Assignee: SONY CORPORATION, Tokyo (JP)

(21) Appl. No.: 13/743,307

(22) Filed: Jan. 16, 2013

(30) Foreign Application Priority Data
Feb. 1, 2012 (JP) 2012-019828

(51) Int. Cl. H04B 10/25

(52) U.S. Cl. CPC H04B 10/25
USPC 398/115

(57) ABSTRACT

There is provided a transmission method including transmitting a first signal and a second signal, which is generated in a different manner from the first signal, via one transmission path having a solid-state element.

### BACKGROUND

The present technology relates to a transmission method and a transmission system, and more particularly to a transmission method and a transmission system, for example, by which the size reduction of an apparatus and the like can be implemented.

For example, in digital cameras, an electric signal obtained by imaging in an imaging element such as a complementary metal oxide semiconductor (CMOS) or a charged coupled device (CCD) is processed by a signal processing unit that performs various signal processings. Thus, in the digital cameras, the electric signal is transmitted from the imaging element to the signal processing unit.

Recently, high-speed transmission (transfer) technology has been used for transmission of an electric signal from the imaging element to the signal processing unit so as to cope with a large number of pixels and a high frame rate.

An example of technology for transmitting an electric signal at a high speed is low voltage differential signaling (LVDS).

In LVDS, although a differential signal is transmitted, it is necessary to achieve impedance matching at a termination end so as to perform highly precise transmission (errorless transmission).

However, from the requirement of low power consumption, it is difficult to neglect power consumption due to the impedance matching.

In addition, in LVDS, it is necessary to perform equal-length wiring, which makes lengths of wirings through which a plurality of electric signals are transmitted equal so that a difference in a delay time in the wiring is sufficiently small for the transmission of the plurality of electric signals to be in synchronization with each other.

Because of the constraint that the above-described equal-length wiring should be performed, the difficulty of design of a substrate (printed substrate) (printed wiring board) increases.

Further, in LVDS, there is a method of increasing the number of wirings through which electric signals are transmitted to perform higher-speed transmission.

However, in LVDS, the complexity of the substrate or the complexity of the wiring of a cable that connects substrates increases when the number of wirings through which electric signals are transmitted increases. Further, an increase in the number of wirings results in an increase in the number of terminals of an integrated circuit (IC) for an imaging element, a signal processing unit, and the like, thereby leading to an increase in costs.

For example, in Japanese Patent Application Publication No. 2006-352418, a method of performing communication between a substrate equipped with an imaging element and a substrate equipped with a control circuit using wireless communication by light or the like in a digital camera has been proposed.

According to the method of Japanese Patent Application Publication No. 2006-352418, the digital camera can be configured in a small size because a connector for connecting between the substrates or a conductor as a wiring provided on the substrate can be reduced.

Here, in terms of a transmission path for transmitting light, for example, in Japanese Patent Application Publication No. 2005-31185, a method of manufacturing a laminated polymer optical waveguide on which a plurality of waveguide films forming an optical waveguide core are laminated on a light-transmissive cladding film at low costs has been proposed.

In addition, for example, in Japanese Patent Application Publication No. 2010-103982, technology for transmitting millimeter waves between ICs or substrates within an electronic device has been proposed.

In information transmission by millimeter waves or light, because a broad band can be used, high-rate information transmission is possible, and an increase in the number of wirings, an increase in the number of terminals of an IC, or an increase in costs of a connector can be suppressed.

For example, because it is necessary to perform high-speed processing in a signal processing unit that processes the millimeter waves, the signal processing unit by which high-rate information transmission is enabled is a circuit of which a scale, costs, and a power consumption amount are relatively large.

Accordingly, the use of the millimeter waves in only information transmission for which a very high rate is not necessary, for example, for control of the start and stop of an operation of a simple device, is not effective in that a signal processing unit with a large scale at high costs becomes necessary and a power consumption amount for a transmission amount of information becomes large.

### SUMMARY

Incidentally, for example, when both information transmission by millimeter waves and information transmission by light are used, it is necessary to separately provide a transmission path for transmitting the millimeter waves and a transmission path for transmitting the light, except for when free space (including an air medium) is adopted as a transmission path.

However, when the transmission path for transmitting the millimeter waves and the transmission path for transmitting the light are separately provided, costs of components increase, costs necessary for assembly increase, and it is difficult to reduce the size of an apparatus.

It is desirable to reduce a size of an apparatus.

In accordance with one embodiment of the present technology, there is provided a transmission method including transmitting a first signal and a second signal, which is generated in a different manner from the first signal, via one transmission path.

In accordance with another embodiment of the present technology, there is provided a transmission system including a first transmission unit configured to transmit a first signal via one transmission path, a second transmission unit configured to transmit a second signal, which is generated in a different manner from the first signal, via the one transmission path, and the one transmission path.

In the above-described embodiments, the first signal is transmitted via the one transmission path, and the second signal, which is generated in a different manner from the first signal, is also transmitted via the one transmission path.

According to the embodiments of the present technology described above, a size of an apparatus can be reduced.

### BRIEF DESCRIPTION OF THE DRAWINGS

FIG. 1 is a block diagram illustrating a configuration example of one embodiment of a transmission system to which the present technology has been applied;

FIG. 2 is a block diagram illustrating a configuration example of first transmission units 11 and 12 and second transmission units 21 and 22;

FIG. 3 is a perspective view and a side view illustrating a configuration example of a transmission system using a hollow waveguide as a composite transmission path 1;

FIG. 4 is a perspective view and a side view illustrating another configuration example of the transmission system using the hollow waveguide as the composite transmission path 1;

FIG. 5 is a cross-sectional view illustrating a configuration example of an optical fiber as the composite transmission path 1;

FIG. 6 is a plan view and a cross-sectional view illustrating a configuration example of a film type optical waveguide surrounded by a dielectric material as the composite transmission path 1;

FIG. 7 is a block diagram illustrating a configuration example of an embodiment of a digital camera to which the present technology has been applied;

FIG. 8 is a block diagram illustrating a configuration example of another embodiment of the digital camera to which the present technology has been applied; and

FIG. 9 is a diagram illustrating a configuration example of an embodiment of an interface (I/F) to which the present technology has been applied.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### Embodiment of Transmission System to Which Present Technology has Been Applied

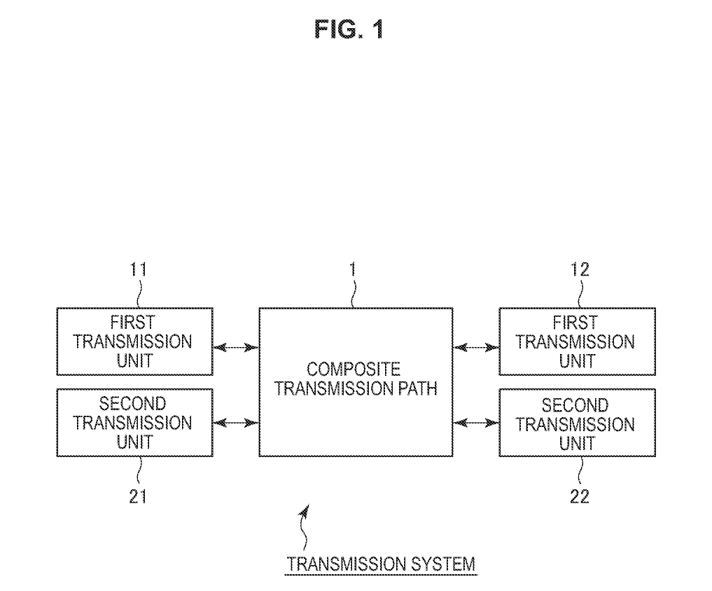

FIG. 1 is a block diagram illustrating a configuration example of one embodiment of the transmission system to which the present technology has been applied.

In FIG. 1, the transmission system has a composite transmission path 1, first transmission units 11 and 12, and second transmission units 21 and 22.

The composite transmission path 1 is one transmission path in which a plurality of signals generated in different manners can be transmitted, and has a structure that induces the plurality of signals generated in the different manners.

Further, the composite transmission path 1 includes at least a solid-state element. Accordingly, a transmission path constituted by only free space (including air or another gas) is excluded from the composite transmission path 1.

In FIG. 1, two signals, i.e., first and second signals, are transmitted as the plurality of signals generated in the different manners via the composite transmission path 1.

The first transmission unit 11 transmits the first signal generated in a predetermined generation manner via the composite transmission path 1.

That is, the first transmission unit 11 transmits the first signal via the composite transmission path 1, and receives the first signal transmitted via the composite transmission path 1.

Like the first transmission unit 11, the first transmission unit 12 transmits the first signal via the composite transmission path 1.

The second transmission unit 21 transmits the second signal, which is generated in a different manner from the first signal, via the composite transmission path 1.

That is, the second transmission unit 21 transmits the second signal via the composite transmission path 1, and receives the second signal transmitted via the composite transmission path 1.

Like the second transmission unit 21, the second transmission unit 22 transmits the first signal via the composite transmission path 1.

In the transmission system configured as described above, for example, the first transmission unit 11 transmits the first signal via the composite transmission path 1, and the first transmission unit 12 receives the first signal transmitted from the first transmission unit 11 via the composite transmission path 1.

Further, for example, the first transmission unit 12 transmits the first signal via the composite transmission path 1, and the first transmission unit 11 receives the first signal transmitted from the first transmission unit 12 via the composite transmission path 1.

In addition, for example, the second transmission unit 21 transmits the second signal via the composite transmission path 1, and the second transmission unit 22 receives the second signal transmitted from the second transmission unit 21 via the composite transmission path 1.

Further, for example, the second transmission unit 22 transmits the second signal via the composite transmission path 1, and the second transmission unit 21 receives the second signal transmitted from the second transmission unit 22 via the composite transmission path 1.

Here, as the plurality of signals generated in the different manners, for example, light such as visible light or infrared light, electric waves such as millimeter waves, sound waves such as ultrasonic waves, or other elastic waves can be adopted.

The light is generated, for example, by electron-hole recombination. The electric waves are generated, for example, by a change in a current in a conductor. In addition, the elastic waves are generated, for example, by vibration of a physical object.

Therefore, the light, the electric waves, and the elastic waves are signals generated in different manners.

For example, the light and the millimeter waves serving as the electric waves can be adopted as the first and second signals.

When the light and the millimeter waves serving as the electric waves are adopted as the first and second signals, for example, a metallic hollow waveguide, a film-type optical waveguide surrounded by a plastic molding or the like such as a substrate serving as a dielectric material, an optical fiber, or the like can be adopted as the composite transmission path 1.

When the light and the millimeter waves are adopted as the first and second signals and the hollow waveguide is adopted as the composite transmission path 1, the light is transmitted in a range to which the light extends within a hollow of the hollow waveguide, and the millimeter waves are transmitted (propagated) in a predetermined propagation mode.

When the light and the millimeter waves are adopted as the first and second signals and the film type optical waveguide surrounded by the substrate is adopted as the composite transmission path 1, the light is transmitted in the film type waveguide and the millimeter waves are transmitted in the film type optical waveguide and a substrate surrounding the film type optical waveguide.

When the light and the millimeter waves are adopted as the first and second signals and the optical fiber is adopted as the composite transmission path 1, the light is transmitted while reflecting within a core constituting the optical fiber, and the millimeter waves are transmitted through the core and a cladding constituting the optical fiber.

In addition, the millimeter waves and the ultrasonic waves serving as the elastic waves can be adopted, for example, as the first and second signals.

When the millimeter waves and the ultrasonic waves serving as the elastic waves are adopted as the first and second signals, for example, the metallic hollow waveguide or the dielectric material or the like such as the substrate can be adopted as the composite transmission path 1.

When the millimeter waves and the ultrasonic waves serving as the elastic waves are adopted as the first and second signals and the hollow waveguide is adopted as the composite transmission path 1, the millimeter waves are transmitted in a predetermined propagation mode within the hollow of the hollow waveguide, and the ultrasonic waves are transmitted within the hollow of the hollow waveguide and through a metal constituting the hollow waveguide with vibration.

When the millimeter waves and the ultrasonic waves serving as the elastic waves are adopted as the first and second signals and the dielectric material is adopted as the composite transmission path 1, the millimeter waves are transmitted through the dielectric material and the ultrasonic waves are transmitted through the dielectric material with vibration.

In addition to the light or the electric waves and the elastic waves serving as the first or second signal, a signal generated in a different manner can be adopted.

In addition, three or more signals generated in different manners as well as the two first and second signals can be transmitted in the composite transmission path 1.

Here, because the millimeter waves are a signal having a frequency of about 30 to 300 gigahertz (GHz), that is, a wavelength of about 1 to 10 mm, and are a signal of a high-frequency band, data can be transmitted at a high rate. As the electric waves, in addition to the millimeter waves, for example, a signal having a terahertz (THz)-order frequency or the like can be adopted.

As described above, because, for example, the millimeter waves, serving as the first signal and, for example, the light, serving as the second signal generated in the different manner from the first signal are transmitted via the composite transmission path 1, which is one transmission path in the transmission system of FIG. 1, it is possible to reduce a size of the transmission system as compared with when a transmission path for transmitting the millimeter waves and a transmission path for transmitting the light are separately provided.

In addition, because the transmission path for transmitting the millimeter waves and the transmission path for transmitting the light are not separately provided and no interference or cross talk is caused, both the information transmission by the millimeter waves and the information transmission by the light can be simultaneously performed and higher-rate information transmission can be performed.

Further, when the transmission system of FIG. 1 is adopted for data transmission between two substrates, because no connector is provided as the electrical contact point with the cable on each substrate as compared with when the two substrates are connected by the cable, there is no electrical contact point and hence the reliability of data transmission can be improved.

### Configuration Example of First Transmission Units 11 and 12 and Second Transmission Units 21 and 22

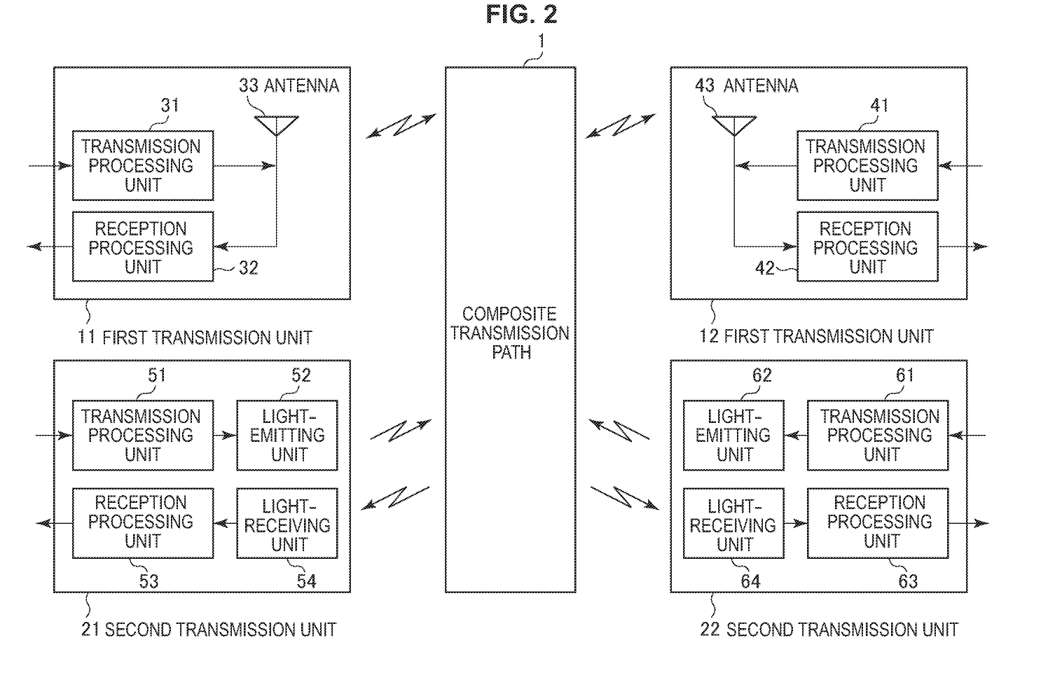

FIG. 2 is a block diagram illustrating a configuration example of the first transmission units 11 and 12 and the second transmission units 21 and 22 of FIG. 1 when millimeter waves are adopted as the first signal and light is adopted as the second signal.

In FIG. 2, the first transmission unit 11 includes a transmission processing unit 31, a reception processing unit 32, and an antenna 33.

According to, for example, baseband data supplied from a block (not illustrated), the transmission processing unit 31 performs a process of modulating millimeter waves as a carrier and a transmission process necessary for transmission of other millimeter waves, and supplies millimeter waves as the modulated signal obtained as the result of the process to the antenna 33.

The reception processing unit 32 performs a process of demodulating the millimeter waves as the modulated signal received by the antenna 33 via the composite transmission path 1 and a reception process necessary for reception of other millimeter waves, and supplies baseband data as the demodulated signal obtained as the result of the process to a block (not illustrated).

The antenna 33 radiates the millimeter waves as the modulated signal supplied from the transmission processing unit 31. The millimeter waves radiated from the antenna 33 are transmitted via the composite transmission path 1.

In addition, the antenna 33 receives the millimeter waves transmitted via the composite transmission path 1, and supplies the received millimeter waves to the reception processing unit 32.

Here, as the antenna 33 that transmits or receives the millimeter waves, a dipole antenna having a length that is about half of a wavelength X of the millimeter waves, that is, for example, a bonding wire of about 1 to 2 mm, can be adopted. For example, in the dipole antenna as the antenna 33, resonance occurs and hence the millimeter waves are efficiently radiated.

If the speed of light is 300 Mm/s, for example, a millimeter-wave wavelength is 300 Mm/s÷60 GHz=5 mm.

The first transmission unit 12 includes a transmission processing unit 41, a reception processing unit 42, and an antenna 43.

Parts ranging from the transmission processing unit 41 to the antenna 43 have substantially the same configurations as parts ranging from the transmission processing unit 31 to the antenna 33, respectively.

The second transmission unit 21 includes a transmission processing unit 51, a light-emitting unit 52, a reception processing unit 53, and a light-receiving unit 54.

The transmission processing unit 51 performs a process of adjusting, for example, a level of baseband data supplied from a block (not illustrated) and another necessary transmission process, and supplies an electric signal obtained as the result of the process to the light-emitting unit 52.

The light-emitting unit 52, for example, includes a light-emitting diode, a laser diode, or the like, and emits light according to the electric signal from the transmission processing unit 51. The light corresponding to the electric signal obtained when the light-emitting unit 52 emits the light according to the electric signal is transmitted via the composite transmission path 1.

The reception processing unit 53 performs a process of adjusting a level of the electric signal supplied from the light-receiving unit 54, and another necessary reception process, and supplies baseband data obtained as the result of the process to a block (not illustrated).

The light-receiving unit 54, for example, includes a phototransistor, a photodiode, or the like. The light-receiving unit 54 receives light transmitted via the composite transmission path 1, and outputs an electric signal corresponding to the light. The electric signal output by the light-receiving unit 54 is supplied to the reception processing unit 53.

The second transmission unit 22 includes a transmission processing unit 61, a light-emitting unit 62, a reception processing unit 63, and a light-receiving unit 64.

Parts ranging from the transmission processing unit 61 to the light-receiving unit 64 have substantially the same configurations as parts ranging from the transmission processing unit 51 to the light-receiving unit 54, respectively.

Among the first transmission units 11 and 12 and the second transmission units 21 and 22 configured as described above, for example, in the first transmission unit 11, the transmission processing unit 31 modulates millimeter waves as a carrier according to baseband data supplied from a block (not illustrated), and transmits a modulated signal of the millimeter waves obtained as the result of the modulation from the antenna 33 via the composite transmission path 1.

The modulated signal of the millimeter waves transmitted from the antenna 33 via the composite transmission path 1 is received by the antenna 44 of the first transmission unit 12 and supplied to the reception processing unit 42.

The reception processing unit 42 demodulates the modulated signal of the millimeter waves from the antenna 43, and supplies baseband data as a demodulated signal obtained as the result of the demodulation to a block (not illustrated).

In addition, for example, in the first transmission unit 12, the transmission processing unit 41 modulates millimeter waves as a carrier according to baseband data supplied from a block (not illustrated), and transmits a modulated signal of the millimeter waves obtained as the result of the modulation from the antenna 43 via the composite transmission path 1.

The modulated signal of the millimeter waves transmitted from the antenna 43 via the composite transmission path 1 is received by the antenna 33 and supplied to the reception processing unit 32.

The reception processing unit 32 demodulates the modulated signal of the millimeter waves from the antenna 33, and supplies baseband data as a demodulated signal obtained as the result of the demodulation to a block (not illustrated).

On the other hand, for example, in the second transmission unit 21, the transmission processing unit 51 performs a transmission process on baseband data supplied from a block (not illustrated), and supplies an electric signal obtained as the result of the process to the light-emitting unit 52.

The light-emitting unit 52 emits light according to the electric signal from the transmission processing unit 51.

The light emitted by the light-emitting unit 52 is transmitted via the composite transmission path 1, and received by the light-receiving unit 64 of the second transmission unit 22.

The light-receiving unit 64 converts the light received by the composite transmission path 1 into a corresponding electric signal, and supplies the electric signal to the reception processing unit 63.

The reception processing unit 63 performs a necessary reception process on the electric signal from the light-receiving unit 64, and supplies baseband data obtained as the result of the reception process to a block (not illustrated).

In addition, for example, in the second transmission unit 22, the transmission processing unit 61 performs a transmission process on baseband data supplied from a block (not illustrated), and supplies an electric signal obtained as the result of the transmission process to the light-emitting unit 62.

The light-emitting unit 62 emits light according to the electric signal from the transmission processing unit 51.

The light emitted by the light-emitting unit 62 is transmitted via the composite transmission path 1, and received by the light-receiving unit 54 of the second transmission unit 21.

The light-receiving unit 54 converts the light received via the composite transmission path 1 into a corresponding electric signal, and supplies the electric signal to the reception processing unit 53.

The reception processing unit 53 performs a necessary reception process on the electric signal from the light-receiving unit 54, and supplies baseband data obtained as the result of the reception process to a block (not illustrated).

As illustrated in FIG. 2, when the first transmission unit 11 includes both the transmission processing unit 31 and the reception processing unit 32, and the first transmission unit 12 includes both the transmission processing unit 41 and the reception processing unit 42, information transmission by millimeter waves can be bi-directionally performed using technology of time division multiplexing, frequency division multiplexing, or the like.

Likewise, when the second transmission unit 21 includes all parts ranging from the transmission processing unit 51 to the light-receiving unit 54 and the second transmission unit 22 includes all parts ranging from the transmission processing unit 61 to the light-receiving unit 64, information transmission by light can be bi-directionally performed.

As a method of bi-directionally performing the information transmission by the light, there are a method using a single-core bi-directional wavelength division multiplexing (WDM) optical transceiver with infrared light, a method using visible light having a different wavelength, a combination thereof, and the like.

Here, information transmission by visible light, for example, is disclosed in Japanese Patent Application Publication No. 2007-81703.

The information transmission by the millimeter waves can be performed in only one direction.

When the information transmission is performed only in a direction from the first transmission unit 11 to the first transmission unit 12, the first transmission unit 11 can be configured with no reception processing unit 32, and the first transmission unit 12 can be configured with no transmission processing unit 41.

In addition, when the information transmission is performed only in a direction from the first transmission unit 12 to the first transmission unit 11, the first transmission unit 11 can be configured with no transmission processing unit 31 and the first transmission unit 12 can be configured with no reception processing unit 42.

Likewise, the information transmission by the light can be performed in only one direction.

When the information transmission is performed only in a direction from the second transmission unit 21 to the second transmission unit 22, the second transmission unit 21 can be configured without the reception processing unit 53 and the light-receiving unit 54, and the second transmission unit 22 can be configured without the transmission processing unit 61 and the light-emitting unit 62.

In addition, when the information transmission is performed only in a direction from the second transmission unit 22 to the second transmission unit 21, the second transmission unit 21 can be configured without the transmission processing unit 51 and the light-emitting unit 52, and the second transmission unit 22 can be configured without the reception processing unit 63 and the light-receiving unit 64.

### Configuration Example of Transmission System Using Hollow Waveguide as Composite Transmission Path 1

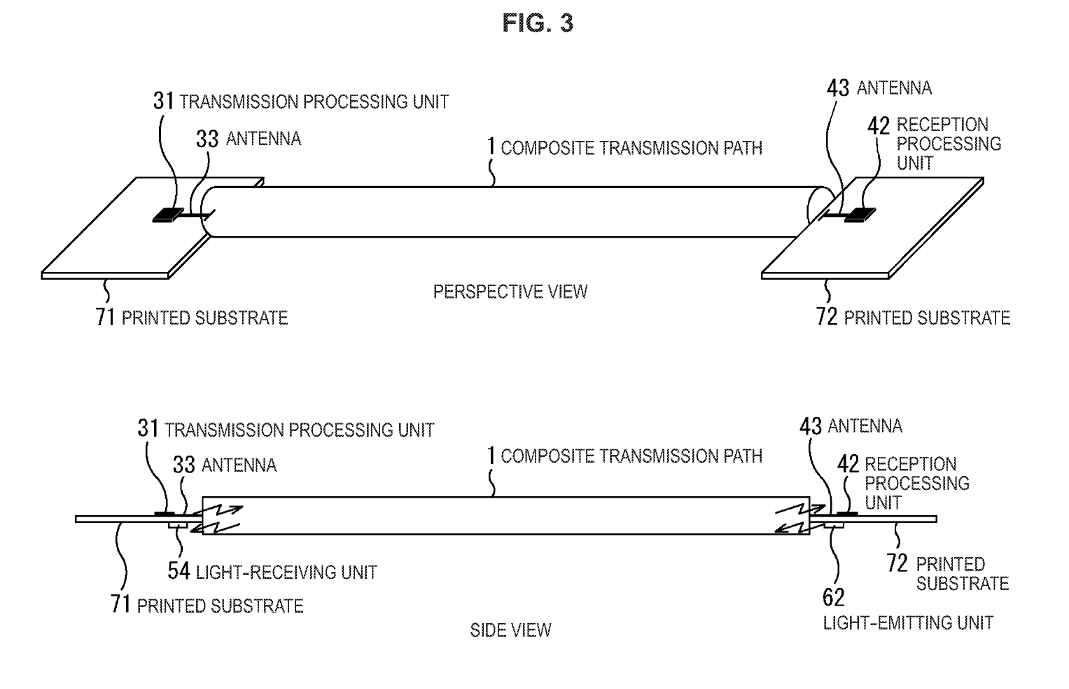

FIG. 3 is a perspective view and a side view illustrating the configuration example of the transmission system using the hollow waveguide as the composite transmission path 1.

In FIG. 3, two substrates (printed substrates) 71 and 72 each having a rectangular plate shape are arranged on the same plane.

Further, in FIG. 3, a metallic cylindrical hollow waveguide is adopted as the composite transmission path 1, and the hollow waveguide serving as the composite transmission path 1 is arranged parallel to (part arrangement planes of) the two substrates 71 and 72.

On the substrate 71, an IC, as the transmission processing unit 31, and the antenna 33 of the first transmission unit 11 are provided on a surface, which is one plane of the substrate 71, and the light-receiving unit 54 of the second transmission unit 21 is provided on the back, which is the other plane.

In FIG. 3, although the reception processing unit 32 of the first transmission unit 11 and the transmission processing unit 51, the light-emitting unit 52, the reception processing unit 53, and the like of the second transmission unit 21 are additionally provided on the substrate 71, illustration thereof is omitted.

On the substrate 72, an IC, as the reception processing unit 42, and the antenna 43 of the first transmission unit 12 are provided on a surface, which is one plane of the substrate 72, and the light-emitting unit 62 of the second transmission unit 22 is provided on the back, which is the other plane.

In FIG. 3, although the transmission processing unit 41 of the first transmission unit 12 and the transmission processing unit 61, the reception processing unit 63, the light-receiving unit 64, and the like of the second transmission unit 22 are additionally provided on the substrate 72, illustration thereof is omitted.

In addition, in FIG. 3, the hollow waveguide serving as the composite transmission path 1 is arranged between the substrates 71 and 72 in the vicinity of or in contact with the antenna 33 and the light-receiving unit 54 on the substrate 71 and the antenna 43 and the light-emitting unit 62 on the substrate 72.

In the transmission system configured as described above, for example, as follows, the millimeter waves and the light are transmitted via one composite transmission path 1, and hence information transmission is performed.

That is, for example, the millimeter waves output by the transmission processing unit 31 are radiated from the antenna 33. The millimeter waves radiated from the antenna 33 are propagated (transmitted) inside the hollow of the hollow waveguide serving as the composite transmission path 1 and received by the antenna 43. The millimeter waves received by the antenna 43 are supplied to the reception processing unit 42.

In addition, for example, although light emitted by the light-emitting unit 62 is received by the light-receiving unit 54 via the inside of the hollow of the hollow waveguide serving as the composite transmission path 1.

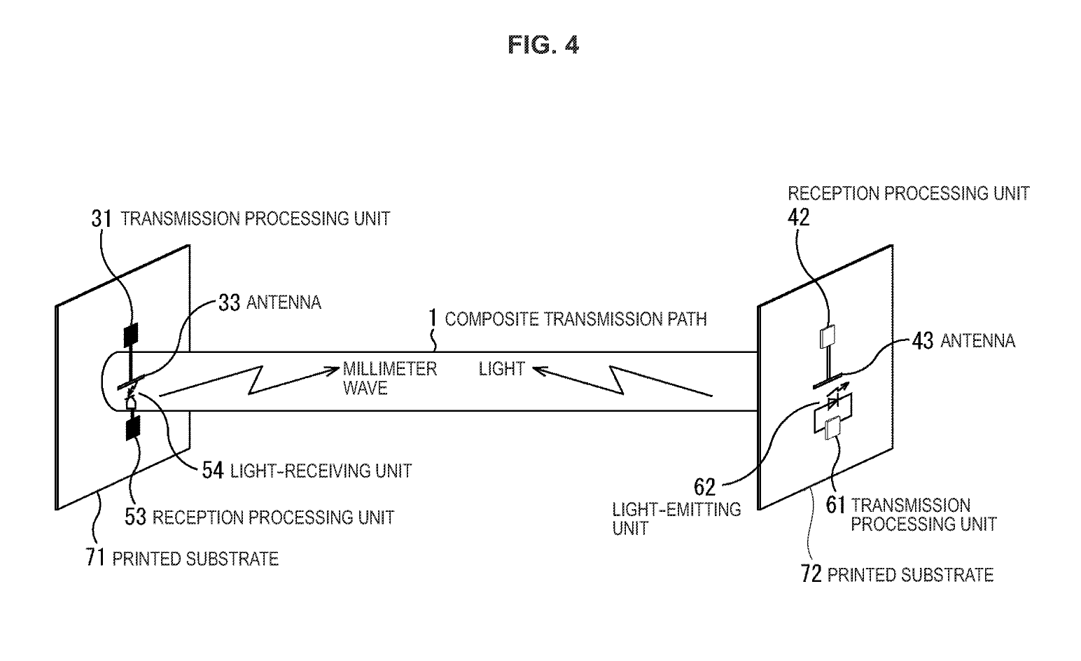

FIG. 4 is a perspective view and a side view illustrating another configuration example of the transmission system using the hollow waveguide as the composite transmission path 1.

In FIG. 4, two substrates 71 and 72 each having a rectangular plate shape are arranged so that planes on which parts are arranged face each other.

Further, in FIG. 4, as in FIG. 3, a metallic cylindrical hollow waveguide is adopted as the composite transmission path 1. In FIG. 4, the hollow waveguide serving as the composite transmission path 1 is arranged perpendicular to (part arrangement planes of) the two substrates 71 and 72.

In the substrate 71, on a surface, which is one plane facing the substrate 72, the IC, as the transmission processing unit 31, and the antenna 33 of the first transmission unit 11 are provided, and the reception processing unit 53 and the light-receiving unit 54 of the second transmission unit 21 are also provided.

In FIG. 4, the light-receiving unit 54 is formed by the phototransistor.

In addition, in FIG. 4, although the reception processing unit 32 of the first transmission unit 11 and the transmission processing unit 51, the light-emitting unit 52, and the like of the second transmission unit 21 are additionally provided on the substrate 71, illustration thereof is omitted.

In the substrate 72, on a surface, which is one plane corresponding to the substrate 71, the IC, as the reception processing unit 42, and the antenna 43 of the first transmission unit 12 are provided, and the transmission processing unit 61 and the light-emitting unit 62 of the second transmission unit 22 are also provided.

In FIG. 4, the light-emitting unit 62 is formed by a light-emitting diode.

In addition, in FIG. 4, although the transmission processing unit 41 of the first transmission unit 12 and the reception processing unit 63, the light-receiving unit 64, and the like of the second transmission unit 22 are additionally provided on the substrate 72, illustration thereof is omitted.

Further, in FIG. 4, the hollow waveguide serving as the composite transmission path 1 is arranged between the substrates 71 and 72 in the vicinity of or in contact with the antenna 33 and the light-receiving unit 54 on the substrate 71 and the antenna 43 and the light-emitting unit 62 on the substrate 72.

In the transmission system configured as described above, for example, the millimeter waves output by the transmission processing unit 31 are radiated from the antenna 33. The millimeter waves radiated from the antenna 33 are propagated inside the hollow of the hollow waveguide serving as the composite transmission path 1 and received by the antenna 43. The millimeter waves received by the antenna 43 are supplied to the reception processing unit 42.

In addition, for example, the light-emitting unit 62 emits light according to an electric signal supplied from the transmission processing unit 61. The light emitted by the light-emitting unit 62 is received by the light-receiving unit 54 via the inside of the hollow of the hollow waveguide serving as the composite transmission path 1, and an electric signal corresponding to a light reception amount is supplied to the reception processing unit 53.

### Other Examples of Composite Transmission Path 1

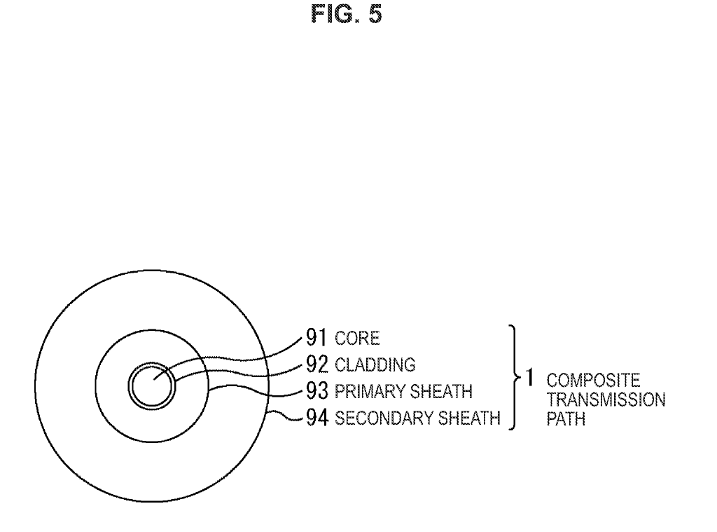

FIG. 5 is a cross-sectional view illustrating a configuration example of an optical fiber as the composite transmission path 1.

As described above, when light and millimeter waves are adopted as the first and second signals, the optical fiber can be adopted as the composite transmission path 1.

In FIG. 5, the optical fiber, for example, is a cylindrical cable, a core 91 is arranged in a center portion of a circle, which is a cross-sectional surface, and a cladding 92 is provided around the core 91. A primary sheath 93 and a secondary sheath 94 are provided to cover the cladding 92.

The core 91, for example, is formed of polymethylmethacrylate (PMMA) (acrylic resin). The cladding 92, for example, is formed of a polymer (a polymer containing fluorine). The primary sheath 93 and the secondary sheath 94, for example, are formed of polyethylene (PE).

A dielectric constant of PMMA is about 3.5 to 4.5, a dielectric constant of the polymer is about 2.0, and a dielectric constant of PE is about 2.3.

When the above-described optical fiber is adopted as the composite transmission path 1, the light is propagated inside the core 91 having a dielectric constant and a refractive index greater than those of the cladding 92 with reflection.

The millimeter waves are propagated by concentrating an electric field on a portion having a high dielectric constant.

Therefore, when the optical fiber is adopted as the composite transmission path 1, the millimeter waves can be propagated by concentrating an electric field on the core 91 using a dielectric constant of the core 91 higher than that of the cladding 92 surrounding the core 91.

However, if the millimeter waves are propagated inside a certain medium, it is necessary to set a diameter of the medium to a size greater than or equal to about half of the wavelength λ of the millimeter wave inside the medium. For example, if a millimeter-wave frequency is 60 GHz and the dielectric constant of the medium is about 3, the diameter of the medium should be about 1.5 mm because the wavelength λ of the millimeter waves inside the medium having a frequency of 60 GHz is about 3 mm.

Therefore, it is necessary to form the diameter of the core 91 to about 1.5 mm when the millimeter waves are propagated by concentrating the electric field on the core 91. Thus, when the diameter of the core 91 increases, an optical propagation mode is thereby affected and consequently an optical transmission rate or transmission distance is affected (degraded).

The diameter of the cladding 92 rather than the core 91 can be increased to the size of about λ/2, a material having a lower dielectric constant than the cladding 92 can be adopted as the primary sheath 93 surrounding the cladding 92, and the millimeter waves can be propagated by concentrating the electric field on the core 91 and the cladding 92. Because the diameter of the cladding 92 does not affect the optical propagation mode, the optical transmission mode or the transmission distance is not affected thereby.

Additionally, the millimeter waves can be propagated by adopting a material of the primary sheath 93 having a higher dielectric constant than the secondary sheath 94 and concentrating the electric field on the core 91, the cladding 92, and the primary sheath 93.

In addition, the millimeter waves can be propagated by adopting a material of the secondary sheath 94 having a higher dielectric constant than air and concentrating the electric field on the core 91, the cladding 92, the primary sheath 93, and the secondary sheath 94.

The millimeter waves are propagated in a predetermined propagation mode. The propagation mode of the millimeter waves represents an electromagnetic field distribution of millimeter waves propagated through a transmission path obtained by solving a wave equation (Maxwell's equation) under a boundary condition determined by a shape of the transmission path in which the millimeter waves are propagated. The propagation mode in which the millimeter waves are propagated is determined by the shape (structure) of the composite transmission path 1.

Here, when the optical fiber is adopted as the composite transmission path 1, the light-emitting units 52 and 62 are arranged, for example, in a position in contact with or in the vicinity of the core 91, so that light emitted by the light-emitting units 52 and 62 is easily incident on the core 91. Likewise, the light-receiving unit 54 and 64 are also arranged, for example, in a position in contact with or in the vicinity of the core 91, so that light output from the core 91 is easily received.

Further, for example, when the millimeter waves are propagated by increasing the diameter of the cladding 92 to the size of about λ/2, adopting a material having a lower dielectric constant than the cladding 92 as the primary sheath 93 surrounding the cladding 92, and propagating the millimeter waves while concentrating the electric field on the core 91 and the cladding 92, the antennas 33 and 43 are arranged, for example, in a position in contact with or in the vicinity of the cladding 92 arranged in an edge portion of the core 91, so that the antennas 33 and 43 do not interfere with the incidence of light emitted by the light-emitting units 52 and 62 on the core 91 and the reception of light output from the core 91 by the light-receiving units 54 and 64.

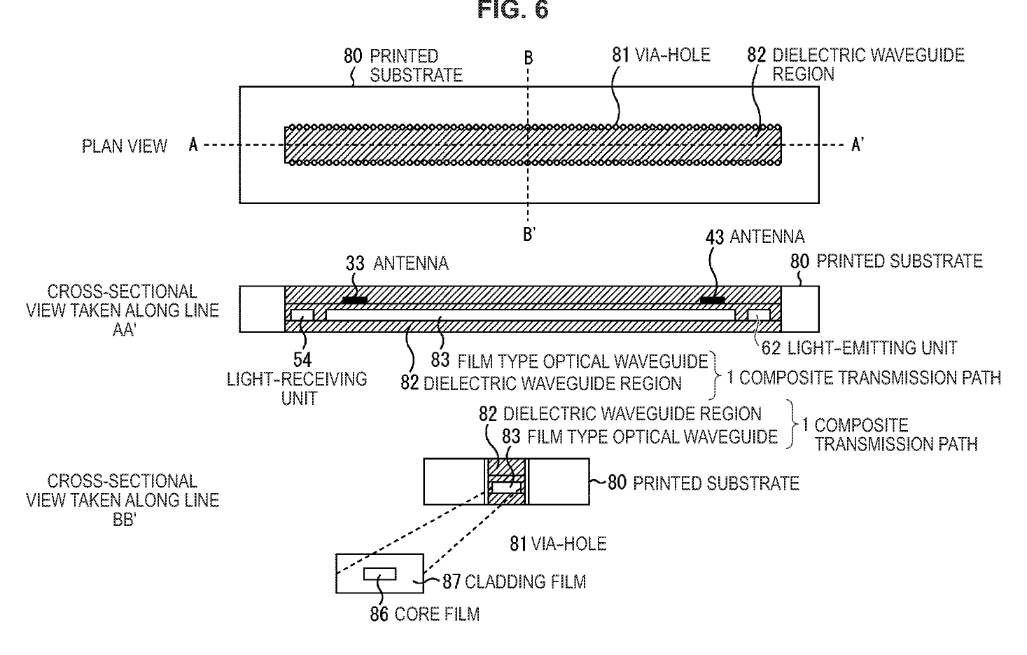

FIG. 6 is a plan view and a cross-sectional view illustrating a configuration example of a film type optical waveguide surrounded by a dielectric material as the composite transmission path 1.

As described above, when the light and the millimeter waves are adopted as the first and second signals, the film type optical waveguide surrounded by the dielectric material can be adopted as the composite transmission path 1.

Here, details of the film type optical waveguide are disclosed, for example, in http://www.hitachi-chem.co.jp/japanese/report/048/48_r3.pdf and the like.

In FIG. 6, on a plate-like substrate 80, a line of via-holes 81 (hereinafter referred to as a via-hole line) arranged at predetermined short intervals is formed.

In FIG. 6, two linear via-hole lines are provided to be spaced at predetermined intervals in parallel, and a dielectric waveguide region 82, which is a region between the above-described two linear via-hole lines, functions as a dielectric waveguide.

Here, for example, as disclosed in Japanese Patent Application Publication No. 2010-103978, a rod-like dielectric waveguide, which supports the two substrates, is arranged between the two substrates arranged facing each other, and millimeter waves are transmitted via the rod-like dielectric waveguide between the two substrates.

In FIG. 6, a rod-like film type optical waveguide 83 is placed inside the dielectric waveguide region 82 of the substrate 80.

A material of the substrate 80, for example, is a dielectric material such as a fluorinated polymer. Therefore, the film type optical waveguide 83 is surrounded by the dielectric waveguide region 82 of the substrate 80, which is the dielectric material.

In FIG. 6, parts of the film type optical waveguide 83 and the dielectric waveguide region 82 of the substrate 80 surrounding the film type optical waveguide 83 form the composite transmission path 1.

Further, in FIG. 6, the light-receiving unit 54 is provided in a position of one end of the rod-like film type optical waveguide 83, and the light-emitting unit 62 is provided in a position of the other end of the rod-like film type optical waveguide 83.

In addition, in FIG. 6, the antenna 33 is provided in a position within the dielectric waveguide region 82 above the light-receiving unit 54 at the side of the one end of the film type optical waveguide 83, and the antenna 43 is provided in a position within the dielectric waveguide region 82 above the light-emitting unit 62 at the side of the other end of the film type optical waveguide 83.

In FIG. 6, although the transmission processing unit 31 and the reception processing unit 32 of the first transmission unit 11 and the transmission processing unit 51, the light-emitting unit 52, the reception processing unit 53, and the like of the second transmission unit 21 are additionally provided at the side of the one end of the film type optical waveguide 83, illustration thereof is omitted.

In addition, in FIG. 6, although the transmission processing unit 41 and the reception processing unit 42 of the first transmission unit 12 and the transmission processing unit 61, the reception processing unit 63, the light-receiving unit 64, and the like of the second transmission unit 22 are additionally provided at the side of the other end of the film type optical waveguide 83, illustration thereof is omitted.

Further, in FIG. 6, the film type optical waveguide 83 has substantially the same configuration as an optical fiber in which a core film 86, which is a film serving as a core, is surrounded by a cladding film 87, which is a film serving as a cladding.

In FIG. 6, light emitted by the light-emitting unit 62 is propagated inside the core film 86 of the film type optical waveguide 83 with reflection, and received by the light-receiving unit 54.

In addition, in FIG. 6, the millimeter waves transmitted from one of the antennas 33 and 43 are propagated by concentrating the electric field on the inside of the dielectric waveguide region 82 including the film type optical waveguide 83, and received by the other of the antennas 33 and 43.

### Configuration Example of Digital Camera to Which Present Technology Has Been Applied

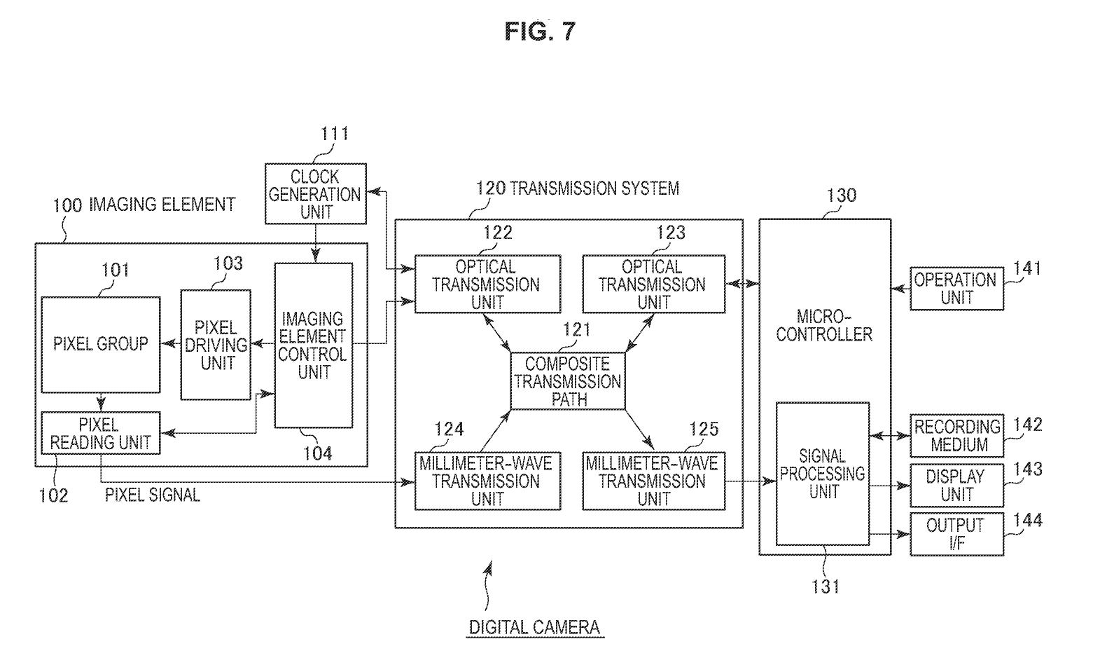

FIG. 7 is a block diagram illustrating a configuration example of an embodiment to which the transmission system of FIG. 2 has been applied as a digital camera to which the present technology has been applied.

In FIG. 7, the digital camera includes an imaging element 100, a clock generation unit 111, a transmission system 120, a microcontroller 130, an operation unit 141, a recording medium 142, a display unit 143, and an output I/F 144.

The imaging element 100 includes a pixel group 101, a pixel reading unit 102, a pixel driving unit 103, and an imaging element control unit 104. The imaging element 100 captures an image and outputs corresponding pixel signals.

That is, the pixel group 101 is a set of pixels, each of which is a light-receiving element configured to receive incident light and generate an electrical signal corresponding to a light reception amount thereof, and is driven by the pixel driving unit 103.

According to control of the imaging element control unit 104, the pixel reading unit 102 reads a pixel signal, which is an electric signal generated by each pixel from the pixel group 101, and supplies the read pixel signal to the millimeter-wave transmission unit 124 of the transmission system 120 to be described later.

The pixel driving unit 103 drives the pixel group 101 according to control of the imaging element control unit 104.

The imaging element control unit 104 operates according to a clock supplied from the clock generation unit 111, and controls the pixel reading unit 102 and the pixel driving unit 103 according to control information from the optical transmission unit 122 of the transmission system 120 to be described later.

In addition, the imaging element control unit 104 supplies state information representing its own state to the optical transmission unit 122 of the transmission system 120.

The clock generation unit 111 generates a clock necessary for control of the imaging element 100 according to the control information from the optical transmission unit 122 of the transmission system 120, and supplies the generated clock to the imaging element control unit 104.

In addition, the clock generation unit 111 supplies state information representing its own state to the optical transmission unit 122 of the transmission system 120.

The transmission system 120 includes a composite transmission path 121, optical transmission units 122 and 123, and millimeter-wave transmission units 124 and 125. The transmission system 120 has substantially the same configuration as the transmission system of FIG. 2, and performs information transmission by light and information transmission by millimeter waves via the one composite transmission path 121.

That is, the composite transmission path 121 has substantially the same configuration as the composite transmission path 1 of FIG. 2.

The optical transmission unit 122 has substantially the same configuration as the second transmission unit 21 of FIG. 2.

The optical transmission unit 122 receives control information transmitted by light via the composite transmission path 121, and supplies the received control information to the imaging element control unit 104 or the clock generation unit 111.

In addition, the optical transmission unit 122 transmits state information supplied from the imaging element control unit 104 or the clock generation unit 111 by light via the composite transmission path 121.

The optical transmission unit 123 has substantially the same configuration as the second transmission unit 22 of FIG. 2.

The optical transmission unit 123 receives the state information transmitted by light via the composite transmission path 121, and supplies the received state information to the microcontroller 130.

In addition, the optical transmission unit 123 transmits the control information supplied from the microcontroller 130 by light via the composite transmission path 121.

The millimeter-wave transmission unit 124 has substantially the same configuration as the first transmission unit 11 of FIG. 2, and transmits the pixel signal supplied from the pixel reading unit 102 by millimeter waves via the composite transmission path 121.

The millimeter-wave transmission unit 125 has substantially the same configuration as the first transmission unit 12 of FIG. 2. The millimeter-wave transmission unit 125 receives the pixel signal transmitted by the millimeter waves via the composite transmission path 121, and supplies the received pixel signal to the signal processing unit 131 of the microcontroller 130 to be described later.

In the embodiment of FIG. 7, in terms of transmission of millimeter waves by the millimeter-wave transmission units 124 and 125, the millimeter waves are transmitted only in a direction from the millimeter-wave transmission unit 124 to the millimeter-wave transmission unit 125, and the millimeter waves are not transmitted in a direction from the millimeter-wave transmission unit 125 to the millimeter-wave transmission unit 124. Thus, the millimeter-wave transmission unit 124 can be configured without a block corresponding to the reception processing unit 32 of FIG. 2, and the millimeter-wave transmission unit 125 can be configured without a block corresponding to the transmission processing unit 41 of FIG. 2.

The microcontroller 130, for example, is configured by a digital signal processor (DSP) or the like, and controls each block constituting the digital camera.

That is, for example, the microcontroller 130 generates control information to control the imaging element control unit 104 or the clock generation unit 111 based on an operation of the operation unit 141 or the state information supplied from the optical transmission unit 123, and supplies the generated control information to the optical transmission unit 123.

In addition, the signal processing unit 131 is embedded in the microcontroller 130.

The signal processing unit 131 performs necessary signal processing such as predetermined color processing on the pixel signals supplied from the millimeter-wave transmission unit 125, and supplies pixel signals, which are pixel signals of one screen (one frame), to the recording medium 142 or the display unit 143 and the output I/F 144.

The operation unit 141, for example, is a physical button, a virtual button displayed on a touch panel, or the like. The operation unit 141 is operated by a user and supplies an operation signal corresponding to the operation to the microcontroller 130.

The recording medium 142, for example, is a memory card, a hard disk, or the like, and an image signal supplied from the signal processing unit 131 is recorded (stored) on the recording medium 142.

The display unit 143 is a liquid crystal display or an organic electro luminescence (EL) display, and displays an image corresponding to the image signal supplied from the signal processing unit 131.

The output I/F 144, for example, is an image I/F such as a high-definition multimedia I/F (HDMI) (registered trademark) normally mounted on an external device that treats an image of a television receiver, a projector, or the like, and outputs the image signal supplied from the signal processing unit 13 to an external device.

In the digital camera configured as described above, the optical transmission unit 122 transmits state information supplied from the imaging element control unit 104 or the clock generation unit 111 by light via the composite transmission path 121. The optical transmission unit 123 receives the state information transmitted by the light and supplies the received state information to the microcontroller 130.

The microcontroller 130 generates control information based on the operation of the operation unit 141 or the state information supplied from the optical transmission unit 123, and supplies the generated control information to the optical transmission unit 123.

The optical transmission unit 123 transmits the control information from the microcontroller 130 by light via the composite transmission path 121, and the optical transmission unit 122 receives the control information transmitted by the light, and supplies the received control information to the clock generation unit 111 or the imaging element control unit 104.

The clock generation unit 111 generates a clock according to the control information from the optical transmission unit 122, and supplies the generated clock to the imaging element control unit 104.

The imaging element control unit 104 controls the pixel reading unit 102 and the pixel driving unit 103 according to the clock from the clock generation unit 111 and the control information from the optical transmission unit 122.

The pixel driving unit 103 drives the pixel group 101 according to control of the imaging element control unit 104. Thereby, in the pixel group 101, light incident on the pixel group 101 is converted into a pixel signal, which is an electric signal.

The pixel reading unit 102 reads the pixel signal from the pixel group 101 according to control of the imaging element control unit 104, and supplies the read pixel signal to the millimeter-wave transmission unit 124.

The millimeter-wave transmission unit 124 transmits the pixel signal from the pixel reading unit 102 by millimeter waves via the composite transmission path 121, and the millimeter-wave transmission unit 125 receives the pixel signal transmitted by the millimeter waves and supplies the received pixel signal to the signal processing unit 131.

The signal processing unit 131 performs necessary signal processing on the pixel signal from the millimeter-wave transmission unit 125, and supplies an image signal obtained as the processing result to the recording medium 142 or the display unit 143 and the output I/F 144.

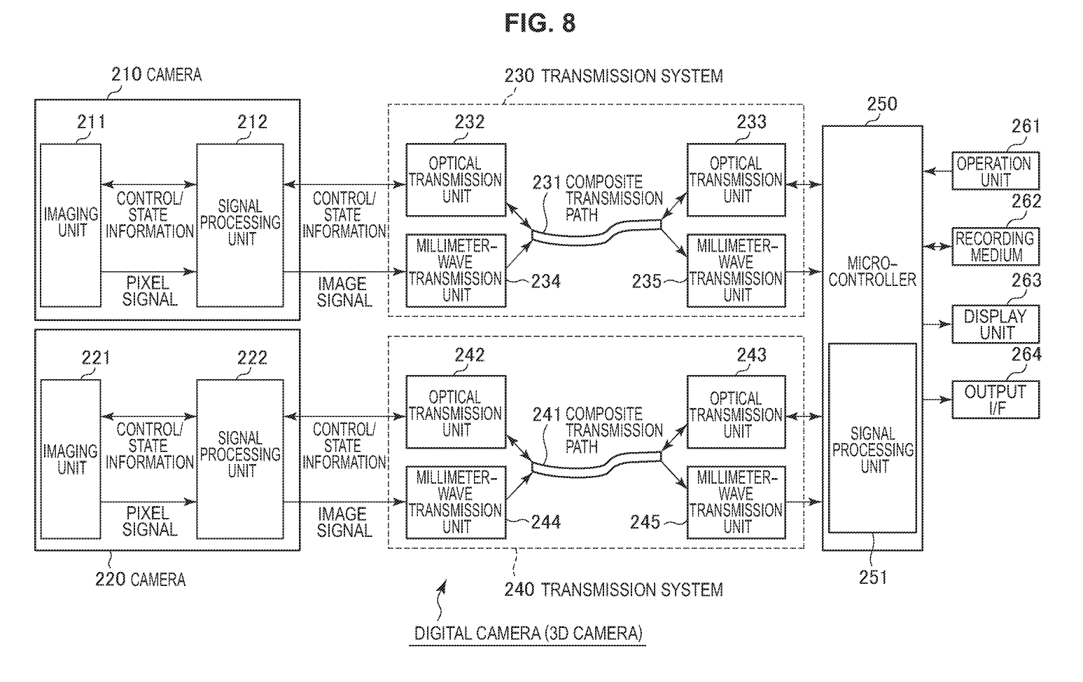

FIG. 8 is a block diagram illustrating a configuration example of another embodiment to which the transmission system of FIG. 2 has been applied as the digital camera to which the present technology has been applied.

In FIG. 8, the digital camera is one type of multi-lens camera, and, for example, is a three-dimensional (3D) camera that captures a 3D image. The digital camera includes cameras 210 and 220, transmission systems 230 and 240, a microcontroller 250, an operation unit 261, a recording medium 262, a display unit 263, and an output I/F 264.

The camera 210 includes an imaging unit 211 and a signal processing unit 212.

The imaging unit 211 has substantially the same configuration as the imaging element 100 and the clock generation unit 111 of FIG. 7, captures an image according to control information supplied from the signal processing unit 212, and outputs corresponding pixel signals to the signal processing unit 212.

In addition, the imaging unit 211 supplies the state information to the signal processing unit 212.

The signal processing unit 212 performs necessary signal processing such as predetermined color processing on the pixel signals supplied from the imaging unit 211, and supplies the pixel signals, which are pixel signals of one screen (one frame) obtained as the processing result, to the transmission system 230.

In addition, the signal processing unit 212 supplies the control information supplied from the transmission system 230 to the imaging unit 211, and also supplies the state information supplied from the imaging unit 211 to the transmission system 230.

The camera 220 includes an imaging unit 221 and a signal processing unit 222.

The imaging unit 221 and the signal processing unit 222 have substantially the same configurations as the imaging unit 211 and the signal processing unit 212, respectively.

The transmission system 230 has substantially the same configuration as the transmission system 120 of FIG. 7.

That is, the transmission system 230 includes a composite transmission path 231, optical transmission units 232 and 233, and millimeter-wave transmission units 234 and 235, and performs information transmission by light and information transmission by millimeter waves via the one composite transmission path 231.

Parts ranging from the composite transmission path 231 to the millimeter-wave transmission unit 235 are substantially the same configurations as parts ranging from the composite transmission path 121 to the millimeter-wave transmission unit 125 of FIG. 7, respectively.

In the transmission system 230, the optical transmission unit 232 receives control information transmitted by light via the composite transmission path 231, and supplies the received control information to the signal processing unit 212.

In addition, the optical transmission unit 232 transmits state information supplied from the signal processing unit 212 by light via the composite transmission path 231.

The optical transmission unit 233 receives the state information transmitted by the light via the composite transmission path 231, and supplies the received state information to the microcontroller 250.

In addition, the optical transmission unit 233 transmits the control information supplied from the microcontroller 250 by the light via the composite transmission path 231.

The millimeter-wave transmission unit 234 transmits the pixel signal supplied from the signal processing unit 212 by millimeter waves via the composite transmission path 231.

The millimeter-wave transmission unit 235 receives the pixel signal transmitted by the millimeter waves via the composite transmission path 231, and supplies the received pixel signal to the microcontroller 250.

The transmission system 240 includes a composite transmission path 241, optical transmission units 242 and 243, and millimeter-wave transmission units 244 and 245, which have substantially the same configurations as the composite transmission path 231, the optical transmission units 232 and 233, and the millimeter-wave transmission units 234 and 235 of the transmission system 230, respectively, and performs information transmission by light and information transmission by millimeter waves via the one composite transmission path 241 as in the transmission system 230.

Therefore, in the transmission system 240, the state information supplied from the signal processing unit 222 is transmitted to the microcontroller 250 by the light. In addition, in the transmission system 240, the control information supplied from the microcontroller 250 is transmitted to the signal processing unit 222 by the light. Further, in the transmission system 240, a pixel signal supplied from the signal processing unit 222 is transmitted to the microcontroller 250 by millimeter waves.

The microcontroller 250 controls blocks constituting the digital camera.

That is, for example, the microcontroller 250 generates control information to control the imaging unit 211 based on an operation of the operation unit 261 or the state information supplied from the optical transmission unit 233, and supplies the generated control information to the optical transmission unit 233.

Further, the microcontroller 250 generates control information to control the imaging unit 221 based on the operation of the operation unit 261 or the state information supplied from the optical transmission unit 243, and supplies the generated control information to the optical transmission unit 243.

In addition, the signal processing unit 251 is embedded in the microcontroller 250.

The signal processing unit 251 generates an image signal of a 3D image from an image signal supplied from the millimeter-wave transmission unit 235 to the microcontroller 250 and an image signal supplied from the millimeter-wave transmission unit 245 to the microcontroller 250, and supplies the generated image signal of the 3D image to the recording medium 262 or the display unit 263 and the output I/F 264.

The operation unit 261, for example, is a physical button, a virtual button displayed on a touch panel, or the like. The operation unit 261 is operated by the user and supplies an operation signal corresponding to the operation to the microcontroller 250.

The recording medium 262, for example, is a memory card, a hard disk, or the like, and an image signal supplied from the signal processing unit 251 is recorded on the recording medium 262.

The display unit 263 is a liquid crystal display or an organic EL display, and displays an image corresponding to the image signal supplied from the signal processing unit 251.

The output I/F 264, for example, is an image I/F such as an HDMI (registered trademark), and outputs the image signal supplied from the signal processing unit 212 to an external device having a corresponding I/F.

In the 3D camera configured as described above, the optical transmission unit 232 transmits state information supplied from the signal processing unit 212 by light via the composite transmission path 231, and the optical transmission unit 233 receives state information transmitted by the light and supplies the received state information to the microcontroller 250.

Likewise, the optical transmission unit 242 transmits the state information supplied from the signal processing unit 222 by light via the composite transmission path 241, and the optical transmission unit 243 receives the state information transmitted by the light and supplies the received state information to the microcontroller 250.

The microcontroller 250 generates control information based on the operation of the operation unit 261 or the state information supplied from the optical transmission unit 233, and supplies the generated control information to the optical transmission unit 233.

The optical transmission unit 233 transmits the control information from the microcontroller 250 by light via the composite transmission path 231, and the optical transmission unit 232 receives the control information transmitted by the light, and supplies the received control information to the imaging unit 211 via the signal processing unit 212.

Further, the microcontroller 250 generates control information based on the operation of the operation unit 261 or the state information supplied from the optical transmission unit 243, and supplies the generated control information to the optical transmission unit 243.

The optical transmission unit 243 transmits the control information from the microcontroller 250 by light via the composite transmission path 241, and the optical transmission unit 242 receives the control information transmitted by the light and supplies the received control information to the imaging unit 221 via the signal processing unit 222.

The imaging unit 211 captures an image according to the control information supplied via the signal processing unit 212, and a pixel signal obtained as the result of the image capture is supplied to the signal processing unit 212.

Likewise, the imaging unit 221 captures an image according to the control information supplied via the signal processing unit 222, and a pixel signal obtained as the result of the image capture is supplied to the signal processing unit 222.

The signal processing unit 212 performs necessary signal processing on a pixel signal from the imaging unit 211, and supplies an image signal obtained as the processing result to the millimeter-wave transmission unit 234.

Likewise, the signal processing unit 222 performs necessary signal processing on a pixel signal from the imaging unit 221, and supplies an image signal obtained as the processing result to the millimeter-wave transmission unit 244.

The millimeter-wave transmission unit 234 transmits the image signal from the signal processing unit 212 by millimeter waves via the composite transmission path 231, and the millimeter-wave transmission unit 235 receives an image signal transmitted by the millimeter waves and supplies the received image signal to the signal processing unit 251.

Likewise, the millimeter-wave transmission unit 244 transmits the image signal from the signal processing unit 222 by millimeter waves via the composite transmission path 241, and the millimeter-wave transmission unit 245 receives the image signal transmitted by the millimeter waves and supplies the received image signal to the signal processing unit 251.

The signal processing unit 251 generates an image signal of a 3D image from the image signal from the millimeter-wave transmission unit 235 and the image signal from the millimeter-wave transmission unit 245, and supplies the generated image signal to the recording medium 262 or the display unit 263 and the output I/F 264.

### Configuration Example of I/F to Which Present Technology has Been Applied

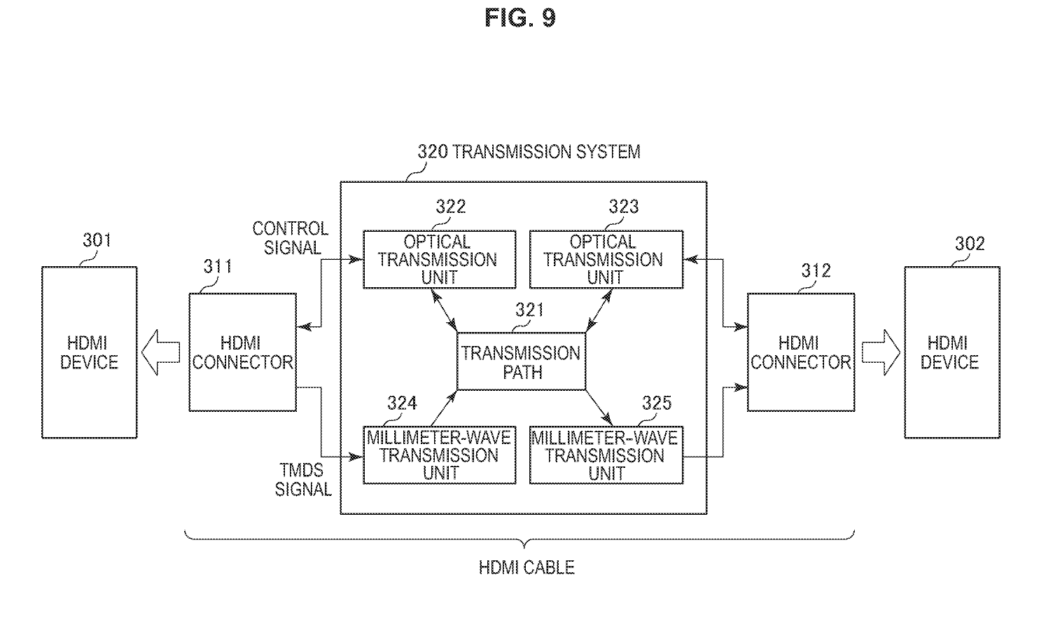

FIG. 9 is a diagram illustrating a configuration example of an embodiment of the I/F to which the transmission system of FIG. 2 has been applied as the I/F to which the present technology has been applied.

That is, FIG. 9 illustrates a configuration example of, for example, an HDMI (registered trademark) cable as the I/F to which the present technology has been applied.

The HDMI (registered trademark) cable is a cable that connects HDMI (registered trademark) devices 301 and 302, which are devices having the I/F of the HDMI (registered trademark).

In FIG. 9, one of the HDMI (registered trademark) devices 301 and 302 is a source device of the HDMI (registered trademark) and the other is a sink device of the HDMI (registered trademark). For example, a recorder or the like that outputs (transmits) an image becomes the source device, and a television receiver or the like that receives the image becomes the sink device.

In FIG. 9, the HDMI (registered trademark) cable includes HDMI (registered trademark) connectors 311 and 312 and a transmission system 320.

The HDMI (registered trademark) connectors 311 and 312 are connectors based on the HDMI (registered trademark), the HDMI (registered trademark) connector 311 is connected to the HDMI (registered trademark) device 301, which is the source device, and the HDMI (registered trademark) connector 312 is connected to the HDMI (registered trademark) device 302, which is the sink device.

The transmission system 320 has substantially the same configuration as the transmission system 120 of FIG. 7.

That is, the transmission system 320 includes a composite transmission path 321, optical transmission units 322 and 323, and millimeter-wave transmission units 324 and 325, and performs information transmission by light and information transmission by millimeter waves via the one composite transmission path 321.

Here, in the HDMI (registered trademark), mainly, a transition minimized differential signaling (TMDS) signal of about several gigabits per second (Gbps) for transmitting a baseband image signal and a control signal, which is an I²C signal of 100 kbps for exchanging information of an image format corresponding to the HDMI device and transmitting high-bandwidth digital content protection (HDCP) authentication information, are transmitted.

As described above, in the HDMI (registered trademark), a high-rate TMDS signal and a low-rate control signal are transmitted.

In the transmission system 320, the high-rate TMDS signal is transmitted, for example, by millimeter waves, which are one of the millimeter waves and light, and the low-rate control signal is transmitted, for example, by the light, which is the other of the millimeter waves and light.

That is, in the transmission system 320, parts ranging from the composite transmission path 321 to the millimeter-wave transmission unit 325 have substantially the same configurations as parts ranging from the composite transmission path 121 to the millimeter-wave transmission unit 125 of FIG. 7, respectively.

The optical transmission unit 322 receives the control signal transmitted by the light via the composite transmission path 321, and supplies the received control signal to the HDMI (registered trademark) connector 311.

In addition, the optical transmission unit 322 transmits the control signal supplied from the HDMI (registered trademark) connector 311 by the light via the composite transmission path 321.

The optical transmission unit 323 receives the control signal transmitted by the light via the composite transmission path 321, and supplies the received control signal to the HDMI (registered trademark) connector 312.

In addition, the optical transmission unit 323 transmits the control signal supplied from the HDMI (registered trademark) connector 312 by the light via the composite transmission path 321.

The millimeter-wave transmission unit 324 transmits the image signal supplied from the HDMI (registered trademark) connector 311 connected to the source device by the millimeter waves via the composite transmission path 321.

The millimeter-wave transmission unit 325 receives the image signal transmitted by the millimeter waves via the composite transmission path 321, and supplies the received image signal to the HDMI (registered trademark) connector 312 connected to the sink device.

As described above, in the HDMI (registered trademark) cable of FIG. 9, by the millimeter waves, the high-rate TMDS signal is transmitted in a direction from the side of the HDMI (registered trademark) connector 311 to the side of the HDMI (registered trademark) connector 312.

Further, in the HDMI (registered trademark) cable of FIG. 9, the low-rate control signal is transmitted by light in two directions of a direction from the side of the HDMI (registered trademark) connector 311 to the side of the HDMI (registered trademark) connector 312 and a direction from the side of the HDMI (registered trademark) connector 312 to the side of the HDMI (registered trademark) connector 311.

Although the transmission system (hereinafter referred to as a millimeter-wave/light composite transmission system) of FIG. 2 to which the present technology has been applied has been described above as being applied to a digital camera or an I/F, the millimeter-wave/light composite transmission system is also applicable to an apparatus that performs various information transmissions.

That is, the millimeter-wave/light composite transmission system can be applied to an information transmission system that performs information transmission by the millimeter waves, for example, from a transmission side to a reception side. When the information transmission is not necessary in this information transmission system, it is desirable to set a circuit of the reception side to a stop state in view of low power consumption.

In this case, when the information transmission by the millimeter waves from the transmission side to the reception side has ended in the information transmission system, the circuit of the reception side should be set from an operation state to the stop state. Further, when the information transmission by the millimeter waves from the transmission side to the reception side has started, the circuit of the reception side should be rapidly set from the stop state to the operation state and should start reception of information transmitted by the millimeter waves.

As a state control method of setting the circuit of the reception side from the operation state to the stop state when the information transmission by the millimeter waves has ended and setting the circuit of the reception side from the stop state to the operation state when the information transmission by the millimeter waves has started, there is a method of monitoring transmission of millimeter waves from the transmission side by intermittently operating a millimeter-wave detection circuit, for example, at the reception side, causing the circuit of the reception side to transition from the operation state to the stop state when the millimeter waves are not detected, and causing the circuit of the reception side to transition from the stop state to the operation state when the millimeter waves are detected. In this case, the millimeter-wave detection circuit is necessary.

The millimeter-wave/light composite transmission system can also be used for state control in addition to information transmission by millimeter waves.

According to the millimeter-wave/light composite transmission system, it is possible to perform information transmission by millimeter waves and perform state control by light.

When the millimeter-wave/light composite transmission system is used for the state control, the millimeter-wave detection circuit is unnecessary because the circuit of the reception side performs state control for transition from one of the operation state and the stop state to the other by light.

In addition, the millimeter-wave/light composite transmission system, for example, can be adopted for data transmission between two substrates. In this case, as compared with when the two substrates are connected by a cable provided with a connector, cost reduction can be implemented because a connector serving as an electrical contact point with the cable is not provided on each substrate and the cable is unnecessary.

Further, because there is no electrical contact point between a connector provided on the substrate side and a cable for connecting the substrates, the reliability of data transmission can be improved due to absence of the electrical contact point.

In addition, according to the millimeter-wave/light composite transmission system, it is possible to reduce power consumption because there is no power consumption due to impedance matching occurring in the LVDS.

Further, because none of impedance matching, equal-length wiring, or the like necessary in the LVDS is necessary in the millimeter-wave/light composite transmission system, it is possible to shorten a time taken to design a substrate necessary for the impedance matching, the equal-length wiring, or the like.

In addition, because the millimeter waves and the light are transmitted via the composite transmission path 1 (FIG. 2), which is one transmission path in the millimeter-wave/light composite transmission system, it is possible to reduce the number of components of an apparatus such as connectors or wiring materials for use in an electrical connection as compared with when the transmission path for transmitting the millimeter waves and the transmission path for transmitting the light are separately provided. As a result, the reduction of costs, the reduction of assembly time, and the size reduction of a device can be implemented.

Further, although wirings exceeding 20 in number, for example, four wirings for use in serial communication, one wiring through which a reset pulse is transmitted, twenty wirings (ten pairs) through which the pixel signal is transmitted by the LVDS, and two wirings (one pair) for transmitting a clock of the LVDS, are necessary when the imaging element 100 and the microcontroller 130 in the digital camera of FIG. 7 are connected by an electrical wiring instead of the transmission system 120, which is the millimeter-wave/light composite transmission system, wirings exceeding 20 in number are unnecessary according to the millimeter-wave/light composite transmission system.

Therefore, it is possible to reduce the number of electrical wirings through which a control signal or a pixel signal is transmitted, an area, and a design time necessary for the wirings according to the millimeter-wave/light composite transmission system.

In addition, although a plurality of impedance-controlled wirings for transmitting an image signal at a rate of about several Gbps from the camera 210 to the microcontroller 250 and a plurality of wirings for transmitting control information between the camera 210 and the microcontroller 250 are necessary when the camera 210 and the microcontroller 250 are connected, for example, by an electrical wiring for LVDS or the like, instead of the transmission system 230, which is the millimeter-wave/light composite transmission system, in the 3D camera of FIG. 8, the above-described wirings are unnecessary according to the millimeter-wave/light composite transmission system.

The same is true even for a connection between the camera 220 and the microcontroller 250.

In addition, in FIG. 8, the camera 210 can be connected to the microcontroller 250 by only the transmission system 230, which is one millimeter-wave/light composite transmission system (the same is true even for the camera 220). Therefore, even when the number of cameras increases, it is possible to easily connect the cameras to the microcontroller 250.

That is, although two cameras, i.e., the cameras 210 and 220, are connected to the microcontroller 250 in FIG. 8, three or more cameras can be connected to the microcontroller 250 and the microcontroller 250 can generate a multiview image from images of the three or more cameras.

In this case, the microcontroller 250 can be connected to each of the three or more cameras by one millimeter-wave/light composite transmission system for every camera, instead of a plurality of wirings as described above.

In addition, as described above, when state control that sets the circuit of the reception side from the operation state to the stop state when information transmission by the millimeter waves has ended and sets the circuit of the reception side from the stop state to the operation state when the information transmission by the millimeter waves has started is performed by intermittently operating the millimeter-wave detection circuit at the reception side, a circuit scale and power consumption of the reception side increase.

On the other hand, when the millimeter-wave/light composite transmission system is used for the state control, that is, for example, when the information transmission is performed by the millimeter waves and the state control is performed by the light, the millimeter-wave detection circuit is unnecessary and the power consumption can be reduced.

That is, the information transmission by the millimeter waves is particularly effective for information transmission at a high rate of about several Gbps to several tens of Gbps. In the millimeter-wave detection circuit effective for the above-described high-rate information transmission, a scale and power consumption increase.

On the other hand, the state control can be performed by the low-rate information transmission, and hence high-rate information transmission is unnecessary for the state control.

Although the light is effective even for the low-rate information transmission and the high-rate information transmission, it is possible to adopt a circuit configuration which is simple and has low power consumption as the second transmission units 21 and 22 that perform optical transmission in the transmission system of FIG. 2, which is the millimeter-wave/light composite transmission system, particularly, for the low-rate information transmission.

That is, in FIG. 2, for example, when the state control of the reception processing unit 42 that receives millimeter waves is performed by light transmitted from the second transmission unit 21 to the second transmission unit 22, the light-receiving unit 64 and the reception processing unit 63 of the second transmission unit 22 that receives the light can be configured, for example, by a photodiode and a simple amplification circuit, respectively.

An output of the reception processing unit 63 is provided to a comparison circuit that performs a comparison with a predetermined threshold value, and the comparison unit performs state control of the reception processing unit 42 that receives millimeter waves according to the comparison result between the output of the reception processing unit 63 and the predetermined threshold value. Accordingly, the state control can be performed by a simple circuit configuration including the photodiode, the amplification circuit, and the comparison circuit.

The photodiode, the amplification circuit, and the comparison circuit have low power consumption as compared with the detection circuit that detects millimeter waves effective for high-rate information transmission. Therefore, power consumption can be reduced.

In addition, according to the millimeter-wave/light composite transmission system, for example, both high-rate information transmission by the millimeter waves and low-rate information transmission by the light can be simultaneously performed without causing interference or cross talk, and a small-size apparatus can be configured and power consumption reduced as compared with when the transmission path for transmitting the millimeter waves and the transmission path for transmitting the light are separately provided.

In the millimeter-wave/light composite transmission system, a cheap and simple circuit configuration, for example, such as a Sony Philips digital I/F (S/PDIF) or a remote commander using infrared light, as adopted for low-rate information transmission by light can be adopted for information transmission by the light.

In addition, the millimeter-wave/light composite transmission system can perform high-rate information transmission on the order of Gbps or the like used for recent information technology (IT), for example, as in information transmission by the millimeter waves, in information transmission by light.

That is, in the millimeter-wave/light composite transmission system, information transmission can be performed by both the millimeter waves and light when a transmission rate by only the millimeter waves is insufficient.

Therefore, it is possible to cope with high-rate data transmission without increasing the number of transmission paths when the high-rate data transmission in which a transmission rate by only the millimeter waves is insufficient is necessary according to the millimeter-wave/light composite transmission system.

In the present specification, the system means a set of constituent elements (apparatuses, modules (components), or the like). All constituent elements may not be arranged in the same housing. Therefore, a plurality of apparatuses housed in separate housings and connected via a network and one apparatus in which a plurality of modules are housed in one housing all refer to the system.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) A transmission method including:

transmitting a first signal and a second signal, which is generated in a different manner from the first signal, via one transmission path having a solid-state element.
(2) The transmission method according to (1),

wherein the first signal is millimeter waves, and

wherein the second signal is light.
(3) The transmission method according to (2), wherein the transmission path is a hollow waveguide, a film type optical waveguide surrounded by a dielectric material, or an optical fiber.
(4) The transmission method according to any one of (1) to (3), wherein the first and second signals are transmitted between two substrates each having a plate shape and being arranged on a single plane, via the transmission path which is arranged parallel to the two substrates.
(5) The transmission method according to any one of (1) to (3), wherein the first and second signals are transmitted between two substrates each having a plate shape and being arranged facing each other, via the transmission path which is arranged perpendicular to the two substrates.
(6) A transmission system including:

a first transmission unit configured to transmit a first signal via one transmission path having a solid-state element;

a second transmission unit configured to transmit a second signal, which is generated in a different manner from the first signal, via the one transmission path; and

the one transmission path.

The present disclosure contains subject matter related to that disclosed in Japanese Priority Patent Application JP 2012-019828 filed in the Japan Patent Office on Feb. 1, 2012, the entire content of which is hereby incorporated by reference.

What is claimed is:

1. A transmission method comprising:
transmitting a first signal and a second signal, which is generated in a different manner from the first signal, via one transmission path having a solid-state element.

2. The transmission method according to claim 1,
wherein the first signal is millimeter waves, and
wherein the second signal is light. 10

3. The transmission method according to claim 2, wherein the transmission path is a hollow waveguide, a film type optical waveguide surrounded by a dielectric material, or an optical fiber.

4. The transmission method according to claim 3, wherein the first and second signals are transmitted between two substrates each having a plate shape and being arranged on a single plane, via the transmission path which is arranged parallel to the two substrates.

5. The transmission method according to claim 3, wherein the first and second signals are transmitted between two substrates each having a plate shape and being arranged facing each other, via the transmission path which is arranged perpendicular to the two substrates.

6. A transmission system comprising:
a first transmission unit configured to transmit a first signal via one transmission path having a solid-state element;
a second transmission unit configured to transmit a second signal, which is generated in a different manner from the first signal, via the one transmission path; and
the one transmission path.
